(19) United States
(12) Patent Application Publication
(10) Pub. No.: US 2026/0091414 A1
(43) Pub. Date: Apr. 2, 2026

(54) APPARATUS AND METHOD FOR PROCESSING SUBSTRATE

(71) Applicant: SEMES CO., LTD., Cheonan-si (KR)

(72) Inventors: Chang Suk OH, Cheonan-si (KR); Nak Hyun SONG, Cheonan-si (KR); Jong Gu LEE, Sangju-si (KR)

(21) Appl. No.: 19/309,361

(22) Filed: Aug. 25, 2025

(30) Foreign Application Priority Data
Oct. 2, 2024 (KR) 10-2024-0133705

(51) Int. Cl. B08B 3/02; B08B 13/00

(52) U.S. Cl. CPC B08B 3/024; B08B 13/00

(57) ABSTRACT

In the present disclosure, provided are a substrate processing apparatus and a substrate processing method. The substrate processing apparatus includes a nozzle moving unit having an arm from and to which a nozzle, among a plurality of nozzles disposed in a nozzle disposition region is attached or detached; and a control unit controlling the nozzle moving unit to reciprocally move the nozzle from the nozzle disposition region to one of a plurality of substrate processing containers disposed in a container disposition region, wherein the control unit controls the nozzle moving unit to hold the nozzle at a nozzle holding point located between the plurality of substrate processing containers, before the nozzle is moved to the substrate processing container.

### CROSS-REFERENCE TO RELATED APPLICATION(S)

This application claims the benefit of a priority to Korean Patent Application No. 10-2024-0133705 filed on Oct. 2, 2024 in the Korean Intellectual Property Office, the entire disclosure of which is incorporated herein by reference for all purposes.

### BACKGROUND

The present disclosure relates to an apparatus for processing a substrate and a method for processing a substrate.

In order to manufacture a semiconductor device, various processes such as cleaning, deposition, photolithography, etching, ion implantation, and the like, are performed.

During the processes described above, when the cleaning, photolithography, and etching processes are performed, a chemical solution is supplied to a substrate.

The chemical solution is supplied through a nozzle, and the nozzle is held in a holding port while the chemical solution is not discharged.

However, in the prior art, there were a plurality of holding points at which a nozzle was held, to correspond to each of a plurality of substrate processing containers, or there was a structure in which a distance from a certain holding point to each of the plurality of substrate processing containers was different.

Due thereto, there may be a limitation that processing of the chemical solution for the substrate of each of the plurality of substrate processing containers is not uniform and a production volume thereof is also reduced.

### SUMMARY

The present disclosure has been created to solve the above-described problems, and an aspect of the present disclosure is to provide a substrate processing apparatus and a substrate processing method that improve productivity and enable uniform substrate processing in a plurality of substrate processing containers.

In order to achieve the object, according to an aspect of the present disclosure, a substrate processing apparatus includes a nozzle moving unit having an arm from and to which a nozzle, among a plurality of nozzles disposed in a nozzle disposition region is attached and detached; and a control unit controlling the nozzle moving unit to reciprocally move the nozzle from the nozzle disposition region to one of a plurality of substrate processing containers disposed in a container disposition region, wherein the control unit controls the nozzle moving unit to hold the nozzle at a nozzle holding point located between the plurality of the substrate processing containers, before the nozzle is moved to the substrate processing container.

The nozzle disposition region may be located outside of the container disposition region, and the nozzle holding point may be located in the middle of a virtual straight line connecting centers of two adjacent substrate processing containers among the plurality of substrate processing containers.

The arm may be configured to be moved linearly and to rotate.

The nozzle moving unit may include a first moving portion configured to move in a first direction, an arrangement direction of the plurality of substrate processing containers; a second moving portion installed in the first moving portion, and configured to move in a second direction, perpendicular to the first direction; and a third moving portion installed in the second moving portion, and configured to move in a third direction, perpendicular to the first direction and the second direction, the third moving portion having the arm, which rotates.

The second moving portion may be disposed in the third direction, and the third moving portion may include a linear driving member installed in the second moving portion; a rotary driving member installed in the second moving portion to move in the third direction, and moved linearly in the third direction by the linear driving member; and the arm installed on the rotary driving member to rotate, and which rotates by the rotary driving member.

After the nozzle is attached to the arm, the control unit may control the second moving portion to move the second moving portion in the second direction, and then control the rotary driving member of the third moving portion to rotate the arm of the third moving portion to arrange the arm in the third direction.

After the arm is arranged in the third direction, the control unit may control the linear driving member of the third moving portion to move the rotary driving member having the arm from the nozzle disposition region to the nozzle holding point, to move the nozzle to the nozzle holding point.

The control unit may control the first moving portion to move the first moving portion, to move the nozzle from the nozzle holding point to the substrate processing container, or move from the substrate processing container to the nozzle holding point.

A nozzle holding port accommodating the nozzle may be installed at the nozzle holding point, and a cleaning solution spraying member spraying a cleaning solution may be installed in the nozzle holding port.

Meanwhile, according to another aspect of the present disclosure, a substrate processing apparatus may be provided, the substrate processing apparatus including: a base unit including a container disposition region and a nozzle disposition region; a plurality of substrate processing containers disposed to be spaced apart from each other in the container disposition region, respectively having a processing space; a support unit disposed in the processing space and supporting a substrate; a plurality of nozzles disposed in the nozzle disposition region; a nozzle moving unit having an arm from and to which a nozzle, among the plurality of nozzles is attached or detached; and a control unit controlling the nozzle moving unit to reciprocally move the nozzle from the nozzle disposition region to one of the plurality of substrate processing containers, wherein the control unit controls the nozzle moving unit to hold the nozzle at a nozzle holding point located between the plurality of substrate processing containers, before the nozzle is moved to the substrate processing container, and the nozzle disposition region is located outside of the container disposition region, wherein the nozzle holding point is located in the middle of a virtual straight line connecting centers of two adjacent substrate processing containers among the plurality of substrate processing containers, wherein the nozzle moving unit includes a first moving portion moving in a first direction, arrangement direction of the plurality of substrate processing containers; a second moving portion installed in the first moving portion, and configured to move in a second direction, perpendicular to the first direction; and a third moving portion installed in the second moving portion, and configured to move in a third direction, perpendicular to the first direction and the second direction, the third moving portion having the arm, which rotates.

According to another aspect of the present disclosure, a substrate processing method may be provided, the substrate processing method including: a nozzle attachment operation of attaching a nozzle among a plurality of nozzles disposed in a nozzle disposition region to an arm of a nozzle moving unit; a nozzle setting operation of moving the nozzle to a nozzle holding point located between a plurality of substrate processing containers disposed in a container disposition region by the nozzle moving unit; a first nozzle holding operation of holding the nozzle at the nozzle holding point; a first nozzle movement operation of moving the nozzle from the nozzle holding point to one substrate processing container among a plurality of substrate processing containers by the nozzle moving unit; a first substrate processing operation of processing a substrate by discharging a chemical solution, using the nozzle, onto the substrate supported by a support unit within a processing space of one substrate processing container among the substrate processing containers; a nozzle return operation of returning the nozzle to the nozzle holding point by the nozzle moving unit; a second nozzle holding operation of holding the nozzle at the nozzle holding point; a second nozzle movement operation of moving the nozzle from the nozzle holding point to the other substrate processing container among a plurality of substrate processing containers by the nozzle moving unit; and a second substrate processing operation of processing a substrate by discharging a chemical solution, using the nozzle, onto the substrate accommodated in the other substrate processing container among the substrate processing containers.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are drawings illustrating a substrate processing apparatus according to the prior art.

FIG. 3 is a perspective view illustrating a substrate processing apparatus according to an embodiment of the present disclosure.

FIG. 4 is a plan view illustrating the substrate processing apparatus of FIG. 3.

FIGS. 5 to 8 are drawings illustrating that a nozzle is moved by the nozzle moving unit of the substrate processing apparatus of FIG. 3.

FIG. 9 is a flow chart illustrating a substrate processing method according to an embodiment of the present disclosure.

### DETAILED DESCRIPTION

Hereinafter, preferred embodiments of the present disclosure will be described in detail so that those skilled in the art could easily practice the present disclosure with reference to the accompanying drawings. However, in describing a preferred embodiment of the present disclosure in detail, if it is determined that a detailed description of a related known function or configuration may unnecessarily obscure the subject matter of the present disclosure, the detailed description will be omitted. In addition, the same reference numerals are used throughout the drawings for parts having similar functions and actions. In addition, in the present specification, terms such as ‘upper,’ ‘upper portion,’ ‘upper surface,’ ‘lower,’ ‘lower portion,’ ‘lower surface,’ ‘side surface,’ and the like are based on the drawings, and in practice, it may be different depending on a direction in which the components are disposed.

In addition, throughout the specification, when a part is said to be ‘connected’ to another part, this is not only when it is ‘directly connected,’ but also when it is ‘indirectly connected’ with other components therebetween. In addition, ‘including’ a certain component means that other components may be further included without excluding other components unless otherwise stated.

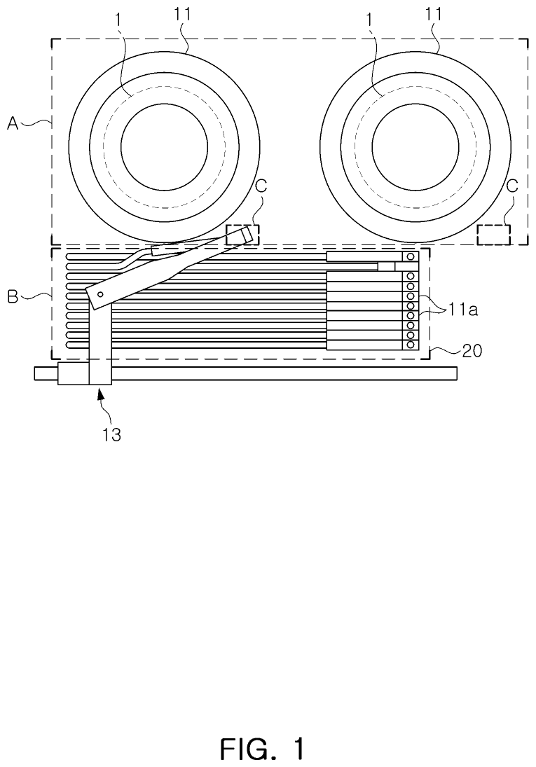

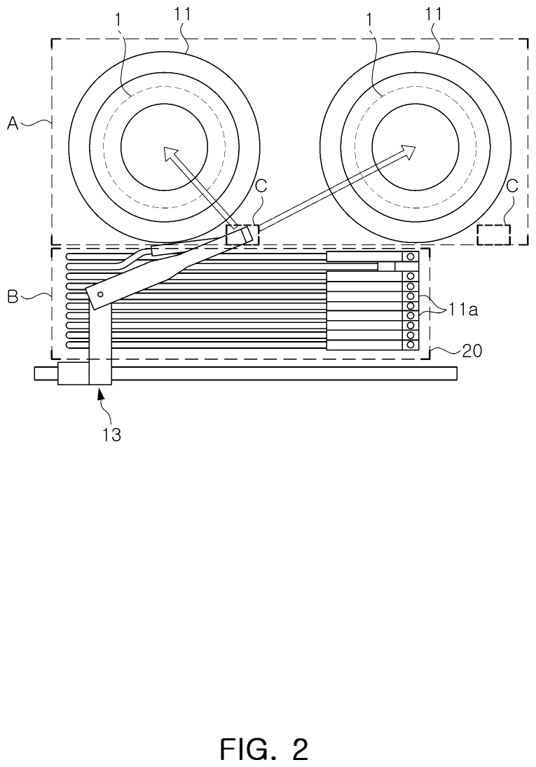

FIGS. 1 and 2 are drawings illustrating a substrate processing apparatus according to the prior art.

Referring to FIGS. 1 and 2, in the substrate processing apparatus according to the prior art, a plurality of substrate processing containers 11 are disposed in a container disposition region (A), and a plurality of nozzles 12 are disposed in a nozzle disposition region (B).

Here, a nozzle holding point (C) at which the nozzle 12 is held is located between the container disposition region (A) and the nozzle disposition region (B).

In this case, when the nozzle holding point (C) is located between the container disposition region (A) and the nozzle disposition region (B), there is a limitation that a production volume thereof is reduced due to a delay in a substrate processing time.

As an example, the nozzle holding point (C) may be located below a leftward side of each of the two substrate processing containers, as illustrated in the drawings.

In particular, when a substrate 1 is sequentially and continuously loaded into a substrate processing container 11 on the leftward side and a substrate processing container 12 on the rightward side, as a substrate processing time obtained by adding the time for the substrate 1 to be processed in the substrate processing container 11 on the leftward side to the time for the substrate 1 to be processed in the substrate processing container 11 on the rightward side increases, a production volume thereof is reduced.

Specifically, when the substrate 1 is sequentially and continuously loaded into the substrate processing container 11 on the leftward side and the substrate processing container 11 on the rightward side, as an example, if the nozzle 12 is moved from the nozzle disposition region (B) by the nozzle moving unit 13 and is held at the nozzle holding point (C) on the rightward side and the substrate is processed, and then the nozzle 12 is moved from the nozzle holding point (C) on the rightward side to the substrate processing container 11 on the leftward side to process the substrate, and then moved to the nozzle holding point (C) on the rightward side by the nozzle moving unit 13 again, and then moved from the nozzle holding point (C) on the rightward side to the substrate processing container 11 on the rightward side to process the substrate.

However, in this case, since a distance from the nozzle holding point (C) on the rightward side to the substrate processing container 11 on the leftward side is further than a distance from the nozzle holding point (C) on the leftward side to the substrate processing container 11 on the leftward side, the time it takes for the nozzle 12 to move to the substrate processing container 11 on the leftward side is relatively long, so the substrate processing time increases.

In addition, since a movement time of the nozzle 12 from the nozzle holding point (C) on the rightward side to the substrate processing container 11 on the leftward side and a movement time of the nozzle 12 from the nozzle holding point (C) on the rightward side to the substrate processing container 11 on the rightward side are different, as a time for a chemical solution to be discharged from the nozzle 12 in the substrate processing container 11 on the leftward side after the substrate 1 is loaded into the substrate processing container 11 on the leftward side, a time for a chemical solution to be discharged from the nozzle 12 in the substrate processing container 11 on the rightward side after the substrate 1 is loaded into the substrate processing container 11 on the rightward side are different, the substrate processing in the substrate processing container 120 on the leftward side and the substrate processing in the substrate processing container 120 on the rightward side are not performed uniformly.

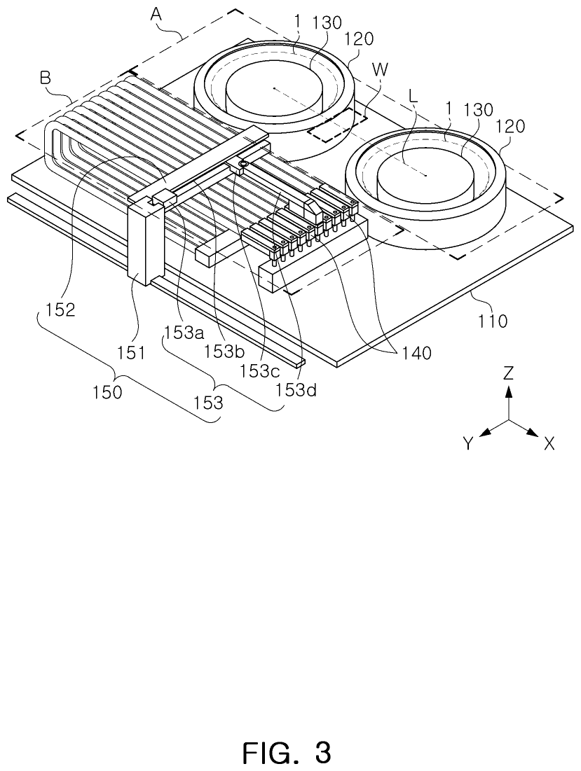

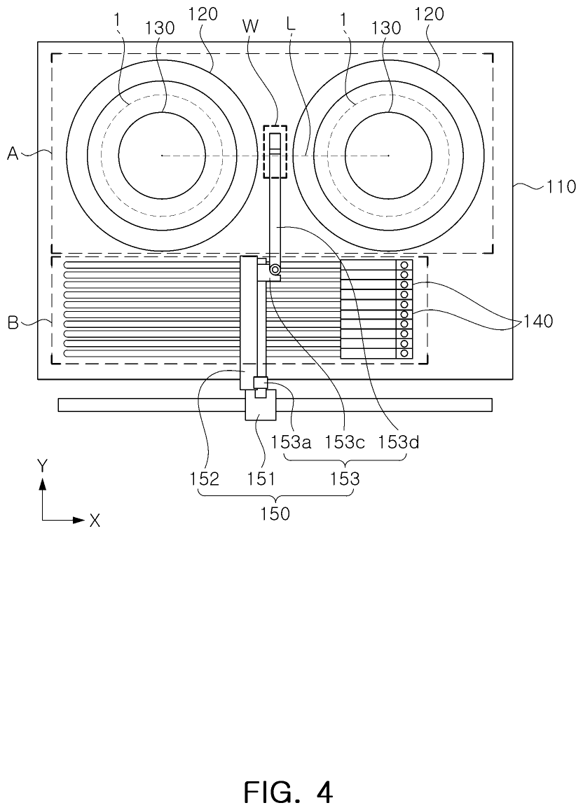

FIG. 3 is a perspective view illustrating a substrate processing apparatus according to an embodiment of the present disclosure, and FIG. 4 is a plan view illustrating the substrate processing apparatus of FIG. 3.

Referring to FIG. 3, the substrate processing apparatus according to an embodiment of the present disclosure may include a base unit 110, a substrate processing container 120, a support unit 130, a nozzle 140, a nozzle moving unit 150, and a control unit (not shown).

The base unit 110 is a unit including a container disposition region (A) and a nozzle disposition region (B), and may have a structure like a flat plate as illustrated in the drawing, as an example, and furthermore, it is sufficient that the base unit 110 may have any conventional structure as long as it can support any other components firmly and stably without being limited by the present disclosure.

Here, the container disposition region (A) is a region in which a plurality of substrate processing containers 120 are disposed, and the nozzle disposition region (B) is a region in which a plurality of nozzles 140 are disposed. In this case, a supply hose having the plurality of nozzles 140 connected thereto is also disposed in the nozzle disposition region (B).

In this case, a plurality of substrate processing containers 120 are disposed to be spaced apart in the container disposition region (A), each of the substrate processing containers having a processing space in which a substrate 1 is processed.

In addition, the support unit 130 is disposed in the processing space of the substrate processing space container 120, and is configured to support a substrate 1 to be processed in the processing space.

In addition, a plurality of nozzles 140 are configured to discharge different types of chemical solutions (e.g., resist), and the plurality of nozzles 140 may be disposed in the nozzle disposition region (B).

The nozzle moving unit 150 is provided with an arm 153d, and the arm 153d is configured so that a nozzle 140 among the plurality of nozzles 140 disposed in the nozzle disposition region (B) is attached or detached.

In addition, the control unit controls the nozzle moving unit 150 moving the nozzle 140.

That is, the control unit may control the nozzle moving unit 150, to move the nozzle 140 from the nozzle disposition region (B) to one of the plurality of substrate processing containers 120, or from one of the plurality of substrate processing containers 120 to the nozzle disposition region (B).

Such a control unit can control the nozzle moving unit 150 to hold the nozzle 140 at a nozzle holding point (W) located between a plurality of substrate processing containers 120, before the nozzle 140 is moved to the substrate processing container 120.

Specifically, the nozzle disposition region (B) is located outside of the container disposition region (A).

In this case, the nozzle holding point (W) may be located in the middle of a virtual straight line (L) connecting centers of two adjacent substrate processing containers 120 among a plurality of substrate processing containers 120.

As an example, the nozzle holding point (W) may be located in the middle of a virtual straight line (L) connecting the centers of the substrate processing container 120 on the leftward side and the substrate processing container 120 on the rightward side, as shown in the drawing.

In this case, when the substrate 1 is sequentially and continuously loaded into the substrate processing container 120 on the leftward side and the substrate processing container 120 on the rightward side, a substrate processing time is shortened, so that a production volume thereof may be improved.

Specifically, since the nozzle holding point (W) is located at the shortest distance from the substrate processing container 120 on the leftward side and the substrate processing container 120 on the rightward side, respectively, the substrate processing time may be shortened as it is possible to reach each of the substrate processing container 120 on the leftward side and the substrate processing container 120 on the rightward side from the nozzle holding point (W) in the shortest time.

In addition, since the movement time of the nozzle 140 from the nozzle holding point (W) to the substrate processing container 120 on the leftward side and the movement time of the nozzle 140 from the nozzle holding point (W) to the substrate processing container 120 on the rightward side are the same, as a time for a chemical solution to be discharged from the nozzle 140 in the substrate processing container 120 on the leftward side after the substrate 1 is loaded into the substrate processing container 120 on the leftward side, a time for a chemical solution to be discharged from the nozzle 140 in the substrate processing container 120 on the rightward side after the substrate 1 is loaded into the substrate processing container 120 on the rightward side are the same, the substrate processing in the substrate processing container 120 on the leftward side and the substrate processing in the substrate processing container 120 on the rightward side may be performed uniformly.

A nozzle holding port (not shown) accommodating a nozzle 140 may be installed at the nozzle holding point (W) described above, and a cleaning solution spraying member (not shown) spraying a cleaning solution may be installed in this nozzle holding port. The cleaning solution spraying member may spray a cleaning solution onto a nozzle tip to clean the nozzle tip, or spray the cleaning solution to form a cleaning solution gas atmosphere to prevent chemical solution at the nozzle tip from drying out and clogging the nozzle 140.

Meanwhile, in order for the nozzle 140 to move from the nozzle disposition region (B) to the nozzle holding point (W) as described above, without passing through an upper space of the substrate processing container 120, the arm 153d of the nozzle moving unit 150 may be configured to move linearly and rotate.

Specifically, the nozzle moving unit 150 may include a first moving portion 151, a second moving portion 152, and a third moving portion 153.

The first moving portion 151 may be configured to move in a first direction (X), an arrangement direction of the plurality of substrate processing containers 120.

In addition, the second moving portion 152 is installed on the first moving portion 151, and may be configured to move in a second direction (Z), perpendicular to the first direction (X).

The third moving portion 153 is installed on the second moving portion 152 and may be configured to move in a third direction (Y), perpendicular to the first direction (X) and the second direction (Z). Such a third moving portion 153 may have an arm 153d which rotates.

Here, the first direction (X) is an arrangement direction of the plurality of substrate processing containers 120 and may be a leftward/rightward direction as illustrated in the drawing, the second direction (Z) is perpendicular to the first direction (X) and is an upward/downward direction as illustrated in the drawing, and the third direction (Y) is perpendicular to the first direction (X) and the second direction (Z), and may be a forward/backward direction as illustrated in the drawing.

More specifically, the third moving portion 153 may include a linear driving member, a rotary driving member 153c, and an arm 153d. Here, the second moving portion 152 may be disposed in the forward/backward direction, which is the third direction (Y).

The linear driving member may be installed in the second moving portion 152.

In addition, the rotary driving member 153c may be installed in the second moving member 152 to move in the third direction (Y), which is the forward and backwards direction, and may move linearly in the third direction (Y), which is the forward and backward direction, by the linear driving member.

As an example, the linear driving member may include a driving motor 153a installed in the second moving portion 152 and a driving belt 153b installed in the forward/backward direction of the second moving portion 152 and connected to the driving motor 153a. The driving belt 153b may rotate in the forward and backward direction by the driving motor 153a, and the rotary driving member 153c may be installed on the driving belt 153b and may move linearly by being linked to the driving belt 153b by the operation of the driving motor 153a.

The arm 153d may be installed on the rotary driving member 153c to rotate, and may rotate by the rotary driving member 153c.

In this case, each of the linear driving member and the rotary driving motor 153a may utilize the driving motor 153a.

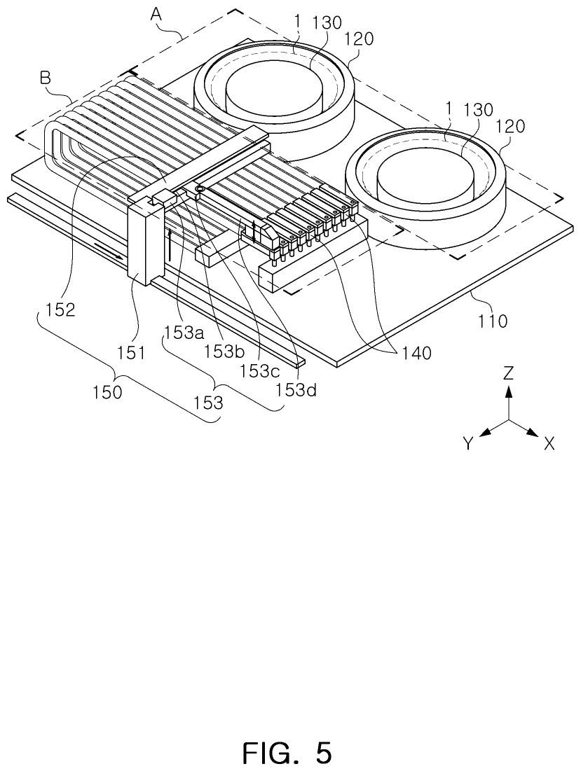

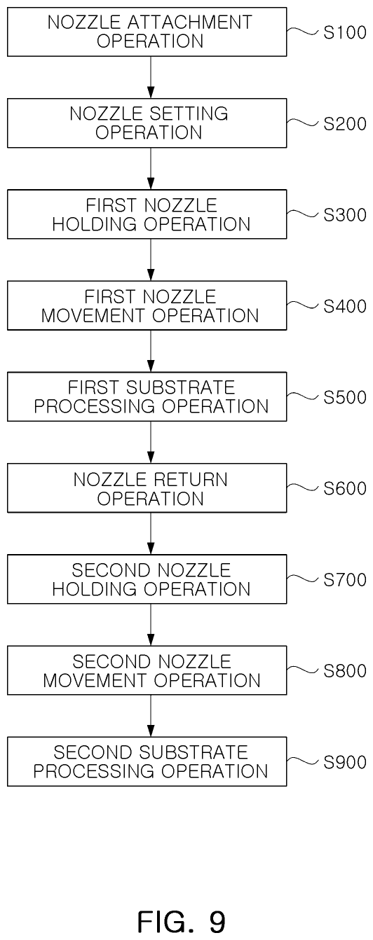

FIGS. 5 to 8 are drawings illustrating that a nozzle is moved by the nozzle moving unit of the substrate processing apparatus of FIG. 3, and FIG. 9 is a flowchart illustrating a substrate processing method according to an embodiment of the present disclosure.

Referring to FIGS. 5 to 8, a nozzle moving unit 150 configured as described above is controlled by a control unit, to move a nozzle 140 from a nozzle disposition region (B) to a nozzle holding point (W), and then move from the nozzle disposition region (B) to the substrate holding point (W).

The substrate processing method including such a configuration may include a nozzle attachment operation (S100), a nozzle setting operation (S200), a first nozzle holding operation (S300), a first nozzle movement operation (S400), a first substrate processing operation (S500), a nozzle return operation (S600), a second nozzle holding operation (S700), a second nozzle movement operation (S800), and a second substrate processing operation (S900).

First, the nozzle attachment operation (S100) is an operation of attaching a nozzle 140 among a plurality of nozzles 140 disposed in the nozzle disposition region (B) to an arm 153d of the nozzle moving unit 150. As described above, a first moving portion 151 and a second moving portion 152 are controlled by a control unit, to move the arm 153d toward the nozzle 140 to attach the nozzle 140 to the arm 153d of the nozzle moving unit 150. As an example, as illustrated in FIG. 5, by the control of such a control unit, the first moving portion 151 in a rightward direction and stops at an appropriate position, and then as the second moving portion 152 moves in a downward direction and the arm 153d descends, the nozzle 140 is attached to the arm 153d. Any conventional fastening method, such as an assembly of unevenness, or the like, may be used as the method of attaching the nozzle 140 to the arm 153d.

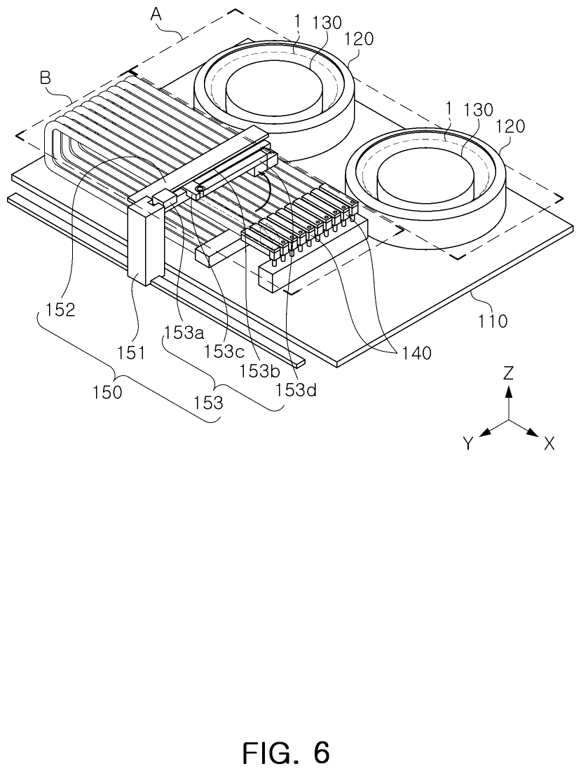

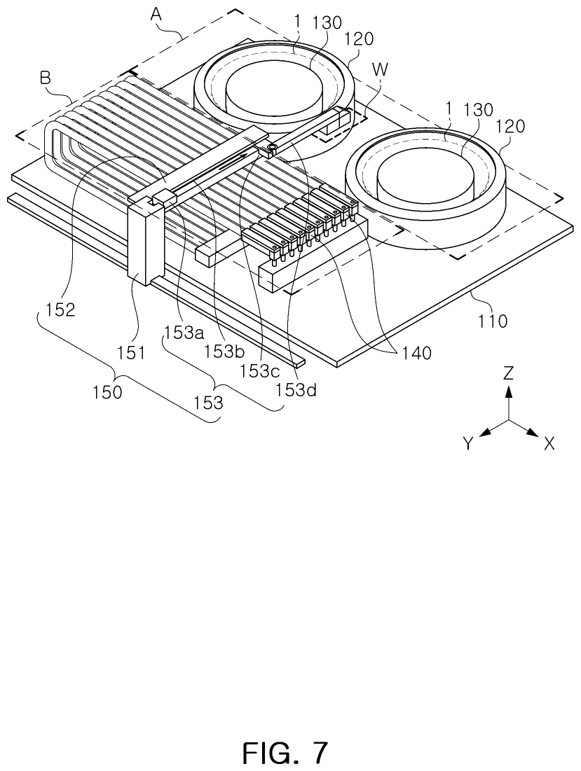

Next, the nozzle setting operation (S200) is an operation of moving the nozzle 140 to a nozzle holding point (W) located between the plurality of substrate processing containers 120 disposed in the container disposition region (A) by the nozzle moving unit 150. Specifically, after the nozzle 140 is attached to the arm 153c in the nozzle attachment operation (S100), and the control unit controls the second moving portion 152 to move the second moving portion 152 in the second direction (Z) in the nozzle setting operation (S200), and then controls the rotary driving member 153c of the third moving portion 153 to rotate the arm 153d of the third moving portion 153 to arrange the same in the third direction (Y). As an example, by the control of such a control unit, as illustrated in FIG. 5, the second moving portion 152 moves in an upward direction and stops at an appropriate position, and then, as illustrated in FIG. 6, the arm 153d of the third moving portion 153 rotates counterclockwise and is arranged in the forward-backward direction. After the arm 153d is arranged in the third direction (Y), the control unit controls the linear driving member of the third moving portion 153 to move the rotary driving member 153c having the arm 153d from the nozzle disposition region (B) to the nozzle holding point (W), to move the nozzle 140 to the nozzle holding point (W). As an example, as illustrated in FIG. 7, by the control of such a control unit, as the arm 153d of the third moving portion 153 moves from the container disposition region (A) to the nozzle holding point (W), the nozzle 140 is moved to the nozzle holding point (W). Meanwhile, a process in which the nozzle 140 is moved from the nozzle disposition region (B) to the substrate processing container 120 by the nozzle moving unit 150 as in the nozzle setting operation (S200) described above may be performed in reverse when the nozzle 140 is moved from the substrate processing container 120 to the nozzle disposition region (B).

Thereafter, a first nozzle holding operation (S300) is an operation of holding the nozzle 140 at a nozzle holding point (W).

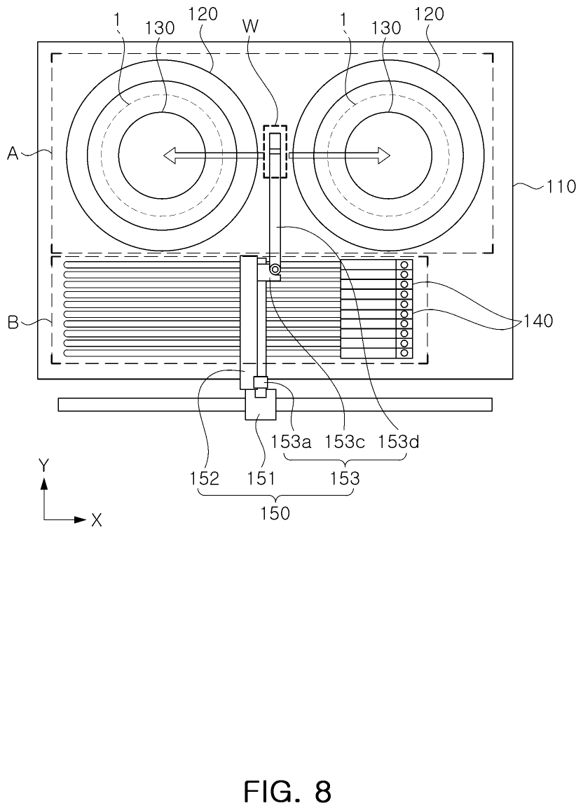

Next, a first nozzle movement operation (S400) is an operation of moving the nozzle 140 from the nozzle holding point (W) to one substrate processing container 120 among the plurality of substrate processing containers 120 by the nozzle moving unit 150. Specifically, in the nozzle setting operation (S200) and the first nozzle holding operation (S300), in a state in which the nozzle 140 is moved to the nozzle holding point (W) is held, in the first nozzle movement operation (S400), the control unit controls the first moving portion 151 to move the first moving portion 151, to move the nozzle 140 from the nozzle holding point (W) to the substrate processing container 120. As an example, as illustrated in FIG. 8, by the control of such a control unit, as the first moving portion 151 moves in a leftward direction or a rightward direction, the nozzle 140 is moved to the substrate processing container 120 on the leftward side or the substrate processing container 120 on the rightward side.

Next, the first substrate processing operation (S500) is an operation of processing a substrate 1 by discharging a chemical solution, using a nozzle 140, onto a substrate 1 supported by a support unit 130 within a processing space of one substrate processing container 120. Specifically, after the nozzle 140 is moved to the substrate processing container 120 in the second nozzle movement operation (S800), in the first substrate processing operation (S500), the chemical solution is discharged from the nozzle 140 onto a substrate 1 located in the substrate processing container 120 to process the substrate.

A nozzle return operation (S600), a second nozzle holding operation (S700), a second nozzle movement operation (S800), and a second substrate processing operation (S900) may be sequentially performed after the first substrate processing operation (S500).

The nozzle return operation (S600) is an operation in which the nozzle 140 is returned to the nozzle holding point (W) by the nozzle moving unit 150, after the first substrate processing operation (S500).

Thereafter, the second nozzle holding operation (S700) is an operation in which the nozzle 140 is held at the nozzle holding point (W).

Next, the second nozzle movement operation (S800) is an operation in which the nozzle 140 is moved from the nozzle holding point (W) to another substrate processing container 120 among the plurality of substrate processing containers 120 by the nozzle moving unit 150. Specifically, in the nozzle return operation (S600) and the second nozzle holding operation (S700), in a state in which the nozzle 140 returns to the nozzle holding point (W) and is held, and in the second nozzle movement operation (S800), the control unit controls the first moving portion 151, to move the first moving portion 151, to move the nozzle 140 from the nozzle holding point (W) to the other substrate processing container 120.

Next, the second substrate processing operation (S900) is an operation of processing a substrate 1 by discharging a chemical solution, using a nozzle 140, onto a substrate 1 accommodated in the other substrate processing container 120.

Furthermore, after the above-described operations, the nozzle 140 may be returned to the nozzle holding point (W) by the nozzle moving unit 150, and the first nozzle holding operation (S300) to the second substrate processing operation (S900) may be repeatedly performed again.

As set forth above, according to the present disclosure, a nozzle is configured to be held at a nozzle holding point located between a plurality of substrate processing containers, before the nozzle is moved to the substrate processing container, productivity may be improved and substrate processing may be uniformly performed in the plurality of substrate processing containers.

While exemplary embodiments have been shown and described above, it will be apparent to those skilled in the art that modifications and variations could be made without departing from the scope of the present invention as defined by the appended claims.

1. A substrate processing apparatus, comprising:
a nozzle moving unit having an arm from and to which a nozzle, among a plurality of nozzles disposed in a nozzle disposition region is attached or detached; and
a control unit controlling the nozzle moving unit to reciprocally move the nozzle from the nozzle disposition region to one of a plurality of substrate processing containers disposed in a container disposition region,
wherein the control unit controls the nozzle moving unit to hold the nozzle at a nozzle holding point located between the plurality of substrate processing containers, before the nozzle is moved to the substrate processing container.

2. The substrate processing apparatus of claim 1, wherein the nozzle disposition region is located outside of the container disposition region, and
the nozzle holding point is located in the middle of a virtual straight line connecting centers of two adjacent substrate processing containers among the plurality of substrate processing containers.

3. The substrate processing apparatus of claim 1, wherein the arm is configured to move linearly and rotate.

4. The substrate processing apparatus of claim 3, wherein the nozzle moving unit includes:
a first moving portion configured to move in a first direction, an arrangement direction of the plurality of substrate processing containers;
a second moving portion installed in the first moving portion, and configured to move in a second direction, perpendicular to the first direction; and
a third moving portion installed in the second moving portion, and configured to move in a third direction, perpendicular to the first direction and the second direction, the third moving portion having the arm, which rotates.

5. The substrate processing apparatus of claim 4, wherein the second moving portion is disposed in the third direction,
wherein the third moving portion includes a linear driving member installed in the second moving portion;
a rotary driving member installed to move in the third direction in the second moving portion, and moved linearly in the third direction by the linear driving member; and
the arm installed to rotate on the rotary driving member, and which rotates by the rotary driving member.

6. The substrate processing apparatus of claim 5, wherein, after the nozzle is attached to the arm,
the control unit controls the second moving portion to move the second moving portion in the second direction, and then controls the rotary driving member of the third moving portion to rotate the arm of the third moving portion and arrange the arm in the third direction.

7. The substrate processing apparatus of claim 6, wherein, after the arm is arranged in the third direction,
the control unit controls the linear driving member of the third moving portion to move the rotary driving member having the arm from the nozzle disposition region to the nozzle holding point, to move the nozzle to the nozzle holding point.

8. The substrate processing apparatus of claim 7, wherein the control unit controls the first moving portion to move the first moving portion, to move the nozzle from the nozzle holding point to the substrate processing container, or move from the substrate processing container to the nozzle holding point.

9. The substrate processing apparatus of claim 1, wherein a nozzle holding port accommodating the nozzle is installed at the nozzle holding point, and
a cleaning solution spraying member spraying a cleaning solution is installed in the nozzle holding port.

10. A substrate processing apparatus, comprising:
a base unit including a container disposition region and a nozzle disposition region;
a plurality of substrate processing containers disposed to be spaced apart from each other in the container disposition region, respectively having a processing space;
a support unit disposed in the processing space, and supporting a substrate;
a plurality of nozzles disposed in the nozzle disposition region;
a nozzle moving unit having an arm from and to which a nozzle, among the plurality of nozzles is attached or detached; and
a control unit controlling the nozzle moving unit to reciprocally move the nozzle from the nozzle disposition region to one of the plurality of substrate processing containers,
wherein the control unit controls the nozzle moving unit to hold the nozzle at a nozzle holding point located between the plurality of substrate processing containers, before the nozzle is moved to the substrate processing container,
the nozzle disposition region is located outside of the container disposition region, and
the nozzle holding point is located in the middle of a virtual straight line connecting centers of two adjacent substrate processing containers among the plurality of substrate processing containers,
wherein the nozzle moving unit includes:
a first moving portion moving in a first direction, an arrangement direction of the plurality of substrate processing containers;
a second moving portion installed in the first moving portion, and configured to move in a second direction, perpendicular to the first direction; and
a third moving portion installed in the second moving portion, and configured to move in a third direction, perpendicular to the first direction and the second direction, the third moving portion having the arm, which rotates.

11. The substrate processing apparatus of claim 10, wherein the second moving portion is disposed in the third direction,
wherein the third moving portion includes
a linear driving member installed in the second moving portion;
a rotary driving member installed in the second moving portion to move in the third direction, and moved linearly in the third direction by the linear driving member; and
the arm installed to rotate on the rotary driving member, and which rotates by the rotary driving member.

12. The substrate processing apparatus of claim 11, wherein, after the nozzle is attached to the arm,
the control unit controls the second moving portion to move the second moving portion in the second direction, and then controls the rotary driving member to rotate the arm and arrange the arm in the third direction.

13. The substrate processing apparatus of claim 12, wherein, after the arm is arranged in the third direction,
the control unit controls the linear driving member to move the arm from the nozzle disposition region to the nozzle holding point together with the rotary driving member, to move the nozzle to the nozzle holding point.

14. The substrate processing apparatus of claim 13, wherein the control unit controls the first moving portion to move the first moving portion, to move the nozzle from the nozzle holding point to the substrate processing container, or move from the substrate processing container to the nozzle holding point.

15. The substrate processing apparatus of claim 10, wherein a nozzle holding port accommodating the nozzle is installed at the nozzle holding point, and
a cleaning solution spraying member spraying a cleaning solution is installed in the nozzle holding port.

16-20. (canceled)
